(19) United States
(12) Patent Application Publication
(10) Pub. No.: US 2011/0075158 A1
(43) Pub. Date: Mar. 31, 2011

(54) OPTICAL CRASH SENSOR

(75) Inventors: SENG WEE QUEK, SINGAPORE (SG); AIK HUANG CHAN, SINGAPORE (SG)

(73) Assignee: DELPHI TECHNOLOGIES, INC., TROY, MI (US)

(21) Appl. No.: 12/569,932

(22) Filed: Sep. 30, 2009

(51) Int. Cl. G01B 11/14

(52) U.S. Cl. 356/615

(57) ABSTRACT

A crash sensor is provided on a vehicle having first and second vehicle structures. The crash sensor includes a light transmitter for emitting a light signal within an opening between the first vehicle structure and the second vehicle structure, and a photo receiver for sensing irradiance in the opening between the first vehicle structure and the second vehicle structure. A change in irradiance or illuminance is indicative of a change in displacement of the first structure relative to the second structure indicative of deformity of the vehicle. The sensor further includes processing circuitry for processing the sensed irradiance and detecting a vehicle crash based on the change in sensed irradiance.

### TECHNICAL FIELD

The present invention generally relates to crash sensors, and more particularly relates to an optical crash sensor for sensing a crash of a vehicle.

### BACKGROUND OF THE INVENTION

Vehicle crash sensors, also referred to as satellite sensors or impact sensors, have been commonly employed on vehicles to sense vehicle dynamics to detect a vehicle crash. Crash sensing systems generally employ crash sensors typically in the form of one or more accelerometers and pressure sensors. The accelerometers detect deceleration of the vehicle. The pressure sensors may serve to provide immunity against inadvertent deployment, particularly for side impact sensing events. However, there are drawbacks associated with the pressure based sensing which include the need for an enclosed air cavity and the inability to discriminate direction of crash.

Accordingly, it is therefore desirable to provide for a sensor that may detect a crash in a vehicle that does not suffer the aforementioned drawbacks of the pressure based sensors.

### SUMMARY OF THE INVENTION

In accordance with one aspect of the present invention, a vehicle crash sensor arrangement is provided. The sensor arrangement includes a first structure of a vehicle, a second structure of the vehicle located a distance from the first structure of the vehicle, and an optical sensor comprising a light transmitter and a photo receiver mounted to one of the first and second vehicle structures and arranged such that the light transmitter emits a light signal and the photo receiver senses irradiance. A change in irradiance is an indication of a change in displacement of the first structure relative to the second structure indicative of deformity of the vehicle. The sensor arrangement further includes processing circuitry for processing the sensed irradiance and detecting a vehicle crash based on the change in sensed irradiance.

According to another aspect of the present invention, a vehicle crash sensor is provided. The vehicle crash sensor comprises a light transmitter connected to a vehicle for emitting a light signal within an opening between a first vehicle structure and a second vehicle structure, and a photo receiver located on the vehicle for sensing irradiance in the opening between the first vehicle structure and the second vehicle structure, wherein a change in the irradiance is indicative of a change in displacement of the first structure relative to the second structure indicative of deformity of the vehicle. The vehicle crash sensor also includes processing circuitry for processing the sensed irradiance and detecting a vehicle crash based on the change in irradiance.

According to a further aspect of the present invention, a method of sensing a change in displacement of a first vehicle structure relative to a second vehicle structure indicative of deformity of the vehicle is provided. The method comprises the steps of transmitting via a light transmitter on a vehicle a light signal in an area between a first vehicle structure and a second vehicle structure, and sensing via a photo receiver on the vehicle irradiance between the first vehicle structure and the second vehicle structure, wherein a change in the irradiance is indicative of a change in displacement of the first structure relative to the second structure indicative of deformity of the vehicle. The method also includes the step of processing the sensed irradiance to determine a change in irradiance and detecting a vehicle crash based on the change in irradiance.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a top view of a vehicle shown generally employing a pair of side impact crash sensors, according to one embodiment;

FIG. 2 is a cross-sectional view taken through line II-II of FIG. 1 illustrating the crash sensor employed between two vehicle structures in a pre-crash state;

FIG. 3 is a cross-sectional view of the crash sensor after a crash which causes a change in irradiance;

FIG. 4 is a block/circuit diagram illustrating the transmit circuitry for emitting light signals with the light transmitter;

FIG. 5 is a block/circuit diagram illustrating the receiver processing circuitry for processing the sensed irradiance;

FIG. 6 is a timing diagram illustrating the transmission and reception of light energy signals employed by the crash sensor;

FIG. 7 is a graph illustrating the change in irradiance compared to a threshold value for determining a crash event; and

FIG. 8 is a block/circuit diagram of integrated transmit and receiver processing circuitry, according to another embodiment.

### DESCRIPTION OF THE PREFERRED EMBODIMENTS

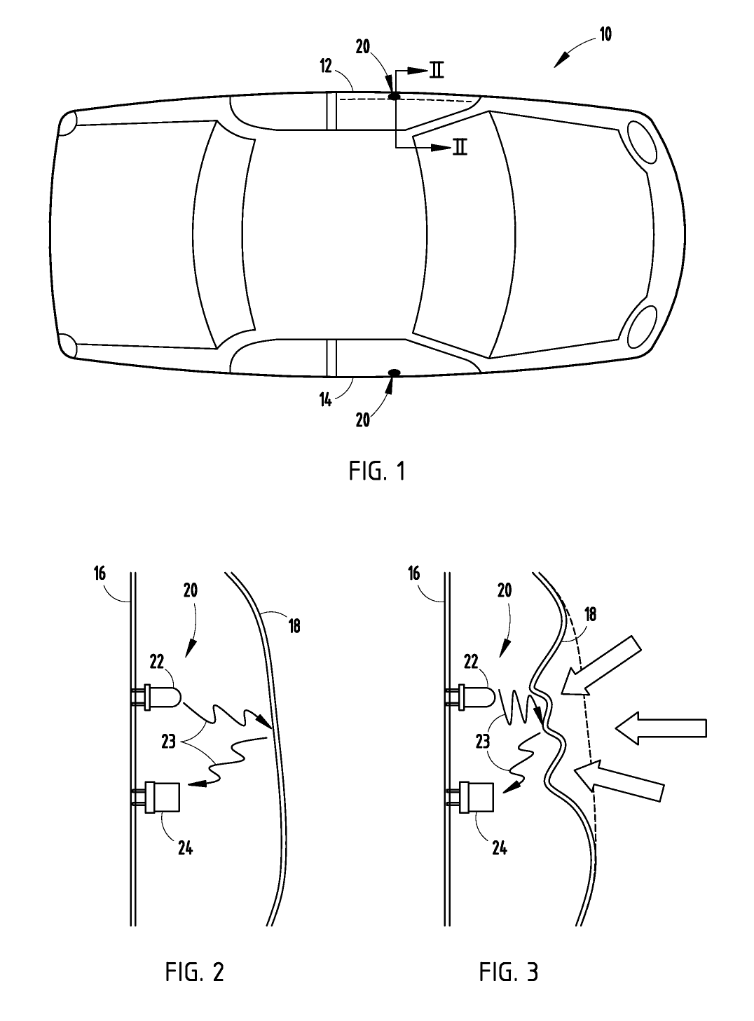

Referring now to FIG. 1, an automotive vehicle 10 is generally illustrated employing a crash sensing system shown having crash sensors 20 located on opposite lateral sides of the vehicle 10. The vehicle 10 may include a wheeled vehicle having road wheels and employs the crash sensing system for mitigation during a crash event, such as the deployment of air bags, pretensioning of seat belts, etc. The crash sensors 20 are shown mounted in the passenger doors 12 and 14, according to one embodiment. However, it should be appreciated that the crash sensors 20 may be mounted elsewhere on the body of the vehicle 10 on opposite lateral sides for side impact, or may be mounted on the front or rear or corners of the vehicle 10 for front or rear crash sensing or other locations as desired. In the embodiment shown, the crash sensors 20 detect a crash with a side impact object impacting the vehicle door at a location proximate to the sensor 20.

Referring to FIGS. 2 and 3, the crash sensor 20 is further illustrated arranged on the vehicle 10 in a non-crash state in FIG. 2 and a post crash state in FIG. 3. The crash sensor 20 is arranged on the vehicle 10 shown connected to a first vehicle structure 16, which may include a frame of the door 12, according to one embodiment. The vehicle 10 also has a second vehicle structure 18, which may include an outer body panel of the vehicle 10. The second structure 18 of the vehicle 10 is located a distance from the first structure of the vehicle, such that there is a space (area) or opening between the first structure 16 and second structure 18. The crash sensor 12 is arranged within the space between the first and second structures 16 and 18 to detect a change in displacement of the first structure 16 relative to the second structure 18 indicative of deformity of the vehicle body and therefore a crash event. Thus, as the outer body 18 is crushed or forced inward during a crash toward the first vehicle structure 16, the crash sensor 20 senses the change in sensed irradiance of transmit light energy which is indicative of a change in displacement of vehicle structures 16 and 18 relative to each other and detects a vehicle collision based on the change in irradiance.

The crash sensor 20 includes a light transmitter 22 located within the space (area) between the first and second structures 16 and 18 for emitting a light signal toward the outer or second vehicle structure 18. According to one embodiment, the light transmitter 22 comprises an infrared (IR) light emitting diode (LED) for emitting IR radiation 23 which reflects off of the inside surface of the second vehicle structure 18. One example of an IR transmitter is a high speed IR emitting diode sold as Part No. TSHG6400 commercially available from Vishay Semiconductors. The light transmitter 22 may include visible and/or non-visible light emission.

Also located within the area between the first and second vehicle structures 16 and 18 is a photo receiver 24 which senses irradiance of light energy. The sensing or irradiance may include sensing light based on illuminance. The photo receiver 24, according to one embodiment, may be a photodiode. Alternatively a phototransistor can be used if slower rise and fall times are acceptable. According to one embodiment, the photo receiver 24 may employ a silicon pin photodiode such as Component No. TESP5700 commercially available from Vishay Semiconductors having a side view lens and daylight blocking filter matched to the high speed IR emitter. It should be appreciated that other transmitters and receivers may be employed, including those qualified for automotive applications. The photo receiver 24 may receive visible and/or non-visible light energy. The receiver 24 may be periodically activated to sense irradiance or illuminance. The sensed irradiance can be measured in units of watts per meter squared (w/m²). The irradiance can be sensed as illuminance which can be measured in units of luminous flux per meter squares (Im/m²). In the embodiment shown, both the light transmitter 22 and receiver 24 are mounted to the first structure 16.

As seen in FIG. 3, during a vehicle collision, when the outside of the second vehicle structure 18 is impacted during a crash with sufficient force causing it to crush or deform and move towards the first vehicle structure 16, the irradiance of light 23 sensed by the photo receiver 24 changes. Generally, the forced movement of the second structure toward the first structure 16 causes an increase in sensed irradiance 23. Sensor 24 senses the increased irradiance 23, which is processed by processing circuitry to determine whether or not a vehicle crash has occurred.

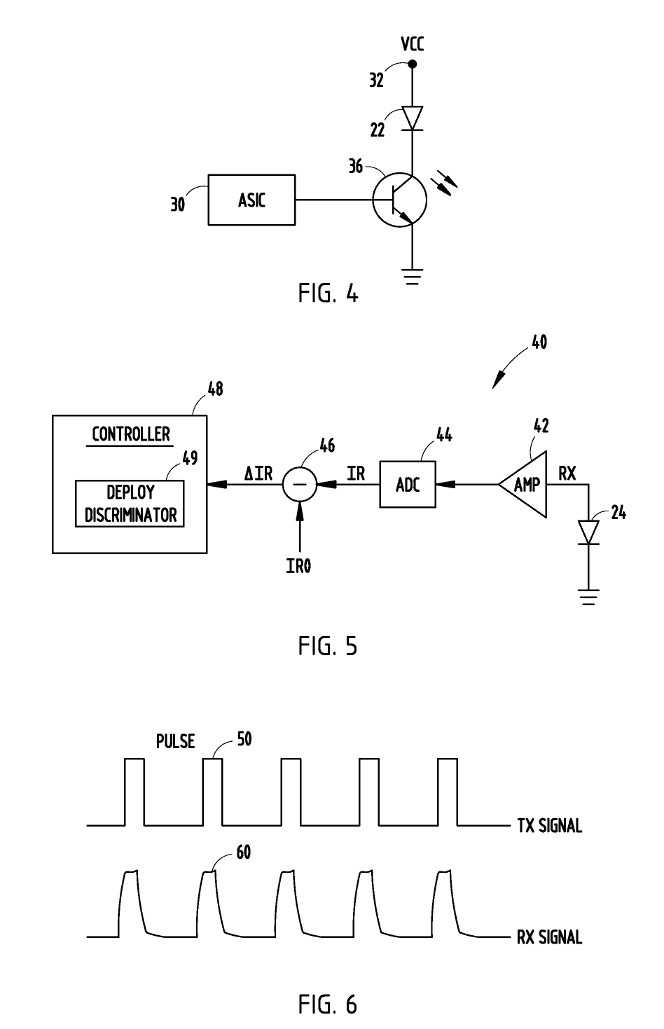

Referring to FIG. 4, the light transmitter circuitry is generally illustrated having an application specific integrated circuit (ASIC) 30 generating a clocked output to a drive transistor 36 on and off such as every one hundred (100) microseconds. Transistor 36 is connected in series with the infrared LED 22 which receives a voltage input VCC at input 32. When drive transistor 36 is turned on, an IR light signal is emitted. By pulsing the IR light emission, reduced power usage of the transmitter is achieved. According the ASIC 30 provides a pulsed signal that generates a pulsed infrared light emission at the IR LED 22.

The processing circuitry 40 for processing the received irradiance is illustrated in FIG. 5, according to one embodiment. As seen, the photo receiver 24, shown as a photodiode, senses irradiance which is input to an amplifier 42 to amplify the sensed light energy signal and then to an analog-to-digital converter (ADC) 44 to convert the analog signal to a digital signal. The digital IR irradiance signal is provided as an input to a subtractor 46, along with an irradiance initialization value IR0. The irradiance initialization value IR0 is the value of irradiance measured during an initialization process. The initialization process may occur when the vehicle is started or periodically such as every one second or frequently as required. IR0 can be input to an automatic gain controller (AGC) to vary the gain of the amplifier so that the IR0 level detected can be in the suitable range. The subtractor 46 generates a change or difference signal between the sensed irradiance IR and the initialization irradiance IR0 which is shown as ΔIR. The ΔIR signal represents the change in irradiance and is input to a controller 48, which includes a deploy discriminator 49. ΔIR signal is digitally coded and can be current or voltage modulated. According to one embodiment, the deploy discriminator 49 compares the ΔIR value to a threshold and, if the ΔIR value exceeds the threshold, generates a collision detection output, according to one embodiment. Prior to a crash, the sensed IR will be approximately equal to IR0 such that ΔIR=0. During a crash, sensed IR will exceed IR0 such that ΔIR exceeds the threshold. The controller 48 may be implemented with a microprocessor or other analog or digital circuitry.

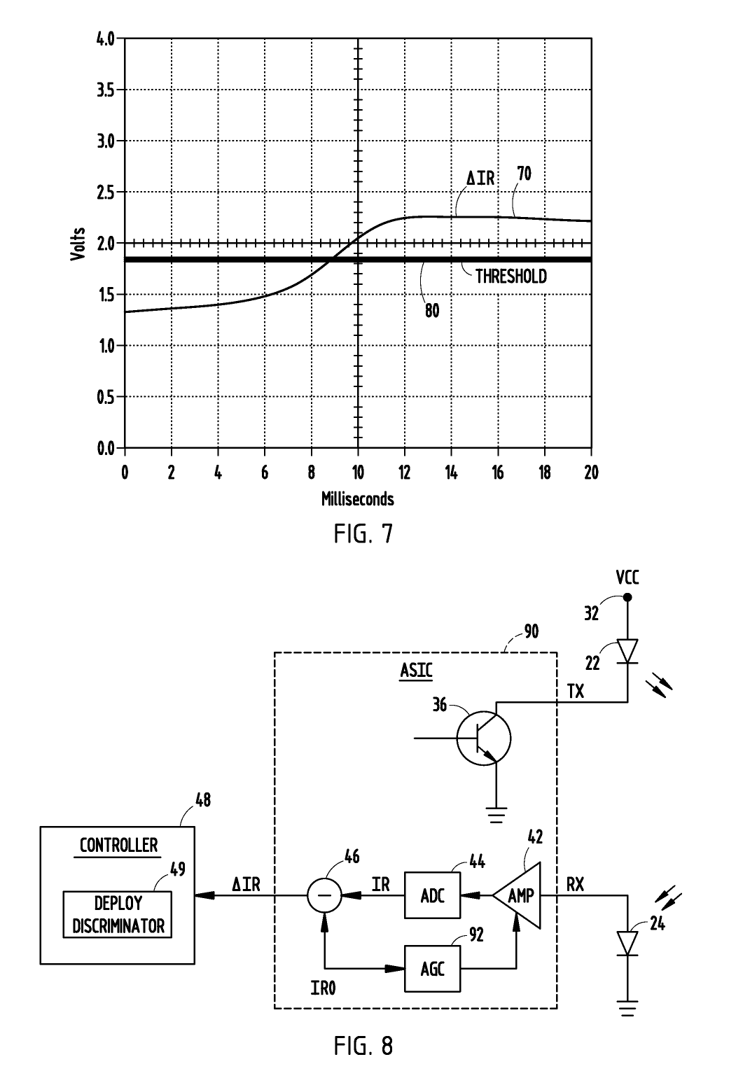

Referring to FIG. 6, the pulsed infrared transmitted light pulses are illustrated in the transmit TX signal, in comparison to the received irradiance RX signal. The transmitted IR TX signal has a high signal 50 that may be pulsed every one hundred (100) microseconds, for example. Each infrared transmission is sensed by the receiver which generates the received RX signal with sensed irradiance at high signals 60. As seen in FIG. 7, when the sensed irradiance changes sufficiently by an amount greater than a threshold value, a crash could be detected or an algorithm is triggered to check for crash events. In doing so, the change in irradiance ΔIR shown by line 70 exceeds the threshold shown by line 80. Once a crash is detected, the sensed crash output may be employed to deploy one or more devices or systems on board the vehicle. For example, one or more air bags, side curtains, seat belt pretensioners and other devices on the vehicle may be deployed. It should be further appreciated that the crash sensor may be employed in combination with a plurality of crash sensors or may be employed in combination with other sensors, such as accelerometers, to improve deployment reliability and immunity against inadvertent deployment and reliably detect a vehicle crash.

Referring to FIG. 8, an integrated crash sensor is shown having an integrated transmitter and receiver, according to another embodiment. In this embodiment, the integrated crash sensor integrates the transceiver and receiver with an application specific integrated circuit (ASIC) 90. Specifically, the IR LED 22 is coupled to transistor 36 within the ASIC 90. The photo receiver 24 is also shown external to the ASIC 90 and providing the receiver input RX to the ASIC 90. In addition, the receiver circuitry includes an automatic gain control (AGC) block 92 which allows for control of the amplifier gain within a suitable voltage range. The amplified signal from amplifier 42 is passed to the ADC 44 and to the subtractor 46 which generates the ΔIR signal. The ΔIR signal is provided to a controller 48 which includes a deploy discriminator logic 49. It should be appreciated that the optical transceiver sends out raw digital messages to the controller 48 which can be a sensing diagnostic module (SDM) or an air bag control unit (ACU), according to various embodiments.

Accordingly, the crash sensor 20 advantageously senses the crash of a vehicle 10 by sensing a change in irradiance resulting from deformation of a first vehicle structure relative to a second vehicle structure. The sensor may advantageously be used in place of conventional pressure sensors.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A vehicle crash sensor arrangement comprising:
a first structure of a vehicle;
a second structure of the vehicle located a distance from the first structure of the vehicle;
an optical sensor comprising a light transmitter and a photo receiver mounted to one of the first and second vehicle structures and arranged such that the light transmitter emits a light signal and the photo receiver senses irradiance, wherein a change in the irradiance is an indication of a change in displacement of the first structure relative to the second structure indicative of deformity of the vehicle; and
processing circuitry for processing the sensed irradiance and detecting a vehicle crash based on the change in sensed irradiance.

2. The sensor arrangement as defined in claim 1, wherein the light transmitter comprises an infrared transmitter for transmitting infrared radiation.

3. The sensor arrangement as defined in claim 2, wherein the infrared transmitter comprises an infrared LED transmitter.

4. The sensor arrangement as defined in claim 1, wherein the light transmitter is pulsed on and off periodically.

5. The sensor arrangement as defined in claim 1, wherein the processing circuitry processes a sensed irradiance and compares the sensed irradiance to an initialized irradiance value.

6. The sensor arrangement as defined in claim 5, wherein the processing circuitry further calculates a difference in the sensed irradiation and the initial irradiance and compares the difference value to a threshold to determine whether a vehicle crash has occurred.

7. The sensor arrangement as defined in claim 2, wherein the photo receiver comprises a photodiode.

8. The sensor arrangement as defined in claim 1, wherein the second vehicle structure comprises a vehicle body member.

9. The sensor arrangement as defined in claim 1, wherein the sensor is mounted on a side of the vehicle to detect side impact of the vehicle.

10. A vehicle crash sensor comprising:
a light transmitter connected to a vehicle for emitting a light signal within an opening between a first vehicle structure and a second vehicle structure;
a photo receiver located on the vehicle for sensing irradiance in the opening between the first vehicle structure and the second vehicle structure, wherein a change in the irradiance is indicative of a change in displacement of the first structure relative to the second structure indicative of deformity of the vehicle; and
processing circuitry for processing the sensed irradiance and detecting a vehicle crash based on the change in sensed irradiance.

11. The sensor as defined in claim 10, wherein the light transmitter comprises an infrared transmitter for transmitting infrared radiation.

12. The sensor as defined in claim 11, wherein the infrared transmitter comprises an infrared LED transmitter.

13. The sensor as defined in claim 10, wherein the light transmitter is pulsed on and off periodically.

14. The sensor as defined in claim 10, wherein the processing circuitry processes a sensed irradiance and compares the sensed irradiance to an initialized irradiance value.

15. The sensor as defined in claim 14, wherein the processing circuitry further calculates a difference in the sensed irradiation and the initial irradiance and compares the difference value to a threshold to determine whether a vehicle crash has occurred.

16. The sensor as defined in claim 12, wherein the photo receiver comprises a photodiode.

17. The sensor as defined in claim 10, wherein the second vehicle structure comprises a vehicle body member.

18. The sensor as defined in claim 10, wherein the sensor is mounted on a side of the vehicle to detect side impact of the vehicle.

19. A method of sensing a change in displacement of a first vehicle structure relative to a second vehicle structure indicative of deformity of the vehicle, said method comprising the steps of:
emitting via a light transmitter on a vehicle a light signal in an area between a first vehicle structure and a second vehicle structure;
sensing via a photo receiver on the vehicle irradiance between the first vehicle structure and the second vehicle structure, wherein a change in the irradiance is an indicative of a change in displacement of the first structure relative to the second structure indicative of deformity of the vehicle;
processing the sensed irradiance to determine a change in irradiance; and
detecting a vehicle crash based on the change in irradiance.

20. The method as defined in claim 19, wherein the step of emitting a light signal comprises emitting an infrared light signal.
